(19) United States
(12) Patent Application Publication
(10) Pub. No.: US 2015/0371627 A1
(43) Pub. Date: Dec. 24, 2015

(54) VOICE DIALOG SYSTEM USING HUMOROUS SPEECH AND METHOD THEREOF

(71) Applicant: POSTECH ACADEMY-INDUSTRY FOUNDATION, Gyeongsangbuk-do (KR)

(72) Inventors: Geun Bae LEE, Pohang-si, Gyeongsangbuk-do (KR); In Jae LEE, Seoul (KR); Dong Hyeon LEE, Gyeongsangnam-do (KR); Yong Hee KIM, Seoul (KR); Seong Han RYU, Seoul (KR); Sang Do HAN, Pohang-si, Gyeongsangbuk-do (KR)

(21) Appl. No.: 14/763,061

(22) PCT Filed: Oct. 16, 2013
(86) PCT No.: PCT/KR2013/009229

§ 371 Date: Jul. 23, 2015

(30) Foreign Application Priority Data
Jan. 25, 2013 (KR) 10-2013-0008478

(51) Int. Cl. G10L 13/10; G10L 15/26; G10L 25/63; G10L 13/04

(52) U.S. Cl. CPC G10L 13/10; G10L 13/043; G10L 15/26; G10L 25/63

(57) ABSTRACT

A voice dialog system and a voice dialog method that generate and use humorous speech are disclosed. The voice dialog system includes a speech analysis unit that analyzes a user's intention by receiving user speech and converting the user speech into text, a humorous speech generation unit that generates humorous speech using a core word or an abbreviated word included in the user speech based on the user's intention, a chatting speech generation unit that generates chatting speech as a response corresponding to the user's intention, and a final speech selection unit that selects final speech from among the humorous speech and the chatting speech. Thus, a user is provided with humorous speech so that the user does not feel bored and has fun using the chatting dialog system.

### TECHNICAL FIELD

The present invention relates to a voice dialog system, and more particularly, to a voice dialog system and a voice dialog method generating and using humorous speech.

### BACKGROUND ART

Dialog systems refer to apparatuses that provide necessary information to users through dialog, using voice or text, and the scope of use of the dialog systems is being gradually expanded to terminals, automobiles, robots, and the like with next-generation intelligent interfaces.

FIG. 1 is a block diagram for describing an operation of a voice dialog system of the related art. In general, in dialog systems of the related art, when user speech is input, the user speech is transformed into text by a voice recognition unit (11) and a user's intention is extracted by a natural language understanding unit (12). A dialog management unit (13) determines a system's intention which can respond to correspond to the user's intention which the natural language understanding unit (12) extracts utilizing record information, example dialog information, and content information of dialogs stored in a database (16). A response generation unit (14) generates system speech based on the determined system's intention and a voice synthesis unit (15) converts the system speech into an actual voice to provide the actual voice as a response to the user.

Dialog systems can be classified into purpose-oriented dialog systems and chatting-oriented dialog systems.

Purpose-oriented dialog systems (purpose dialog systems) are systems which give proper responses to user's questions based on knowledge information of corresponding areas in restricted domains. For example, when a user uses questions to search for information on a specific program, such as a question “Please inform me of today's movie channel” in a smart TV system, a purpose-oriented dialog system understands the user's intention and supplies the user with a response corresponding to the user's intention, such as “Mandeukee is broadcasted on MBC.”

Chatting-oriented dialog systems (chatting dialog systems) are dialog systems which process dialogs for fun or chatting without restriction on domains and with no specific purposes in dialogs. For example, a sentence “I really like to play basketball with my friends” does not pertain to a specific domain and is a speech occurring in daily life. A chatting dialog system should recognize various types of speech occurring in general situations and generate responses to the various types of speech. An object of a chatting dialog system is to maintain natural and fun dialogs with no specific object. Therefore, in order to construct the chatting dialog system, it is necessary to collect corpuses which can be used for general situations and can be used for various situations and to train and operate systems.

That is, while the corpuses are generally collected in units of domains in voice dialog systems, it is necessary to collect various types of corpuses in chatting dialog systems because of the lack of restriction on domains for constructing systems and it is necessary to collect general speech applicable to any situation.

Chatting dialog systems can use example-based dialog management schemes. Such systems provide methods of searching for pairs of dialogs which are the most similar to input a user's speech and supplying the pairs of dialogs as system speech as methods of constructing the systems based on dialog examples (pairs of a user's speech and a system's speech). According to these methods, it is possible to train systems using actual examples and generate natural system responses.

However, since situations and dialog flows occurring in chatting dialog systems are diverse, it is difficult to acquire training data in consideration of all of the various flows. Further, when proper examples corresponding to a user's speech may not obtained via training data, there are problems in which it may be difficult to maintain natural dialogs and dialogs become bored.

### DISCLOSURE

### Technical Problem

An object of the present invention for solving the foregoing problems is to provide a voice dialog system capable of maintaining natural and interesting dialogs as a response to user's speech.

Another object of the present invention for solving the foregoing problems is to provide a voice dialog method of maintaining natural and interesting dialogs as a response to user's speech using the voice dialog system.

### Technical Solution

According to an aspect of the present invention for achieving the foregoing objects, a voice dialog system includes: a speech analysis unit that analyzes a user's intention by receiving user speech and converting the user speech into text; a humorous speech generation unit that generates humorous speech using a core word or an abbreviated word included in the user speech based on the user's intention; a chatting speech generation unit that generates chatting speech as a response corresponding to the user's intention; and a final speech selection unit that selects final speech from among the humorous speech and the chatting speech.

Here, the humorous speech generation unit may generate the humorous speech by selecting the core word from the user speech, performing pronunciation string conversion on the core word in units of pronunciation, selecting an example sentence from among sentences including a word similar to the core word pronunciation string, and substituting the word similar to the core word pronunciation string in the example sentence with the core word.

Here, the humorous speech generation unit may extract words similar to the core word pronunciation string based on a phonological dictionary or a phonological similarity table, calculate word similarity, arrange the words similar to the core word pronunciation string using the word similarity as a criterion, and select the example sentence from among sentences including the words similar to the core word pronunciation string.

Here, the phonological dictionary may be a uni-gram phonological dictionary or a bi-gram phonological dictionary.

Here, the humorous speech generation unit may extract the abbreviated word included in the user speech, retrieve an original word having an original meaning of the abbreviated word, and generate the humorous speech using an initial sound character generated based on different words identical to an initial sound of the original word.

Here, the humorous speech generation unit may restore an original sentence by retrieving the original meaning of the abbreviated word using an abbreviated word dictionary or web information and selecting the original word corresponding to the abbreviated word, and generate the humorous speech by changing the original sentence using the initial sound character.

Here, the humor speech generation unit may include at least one humor generation module generating the humor speech in accordance with a different scheme.

Here, the final speech selection unit may select the final speech from among the humorous speech and the chatting speech based on a similarity score of the humorous speech or a probability value indicating sentence naturalness in accordance with the humorous speech.

Here, the voice dialog system may further include a system speech supply unit that generates system speech which is a response to the user speech using the final speech and converts the system speech into a voice to provide the voice.

According to another aspect of the present invention for achieving the foregoing objects, a voice dialog method processed in a voice dialog system includes: analyzing a user's intention by receiving user speech and converting the user speech into text; generating humorous speech using a core word or an abbreviated word included in the user speech based on the user's intention; generating chatting speech as a response corresponding to the user's intention; and selecting final speech from among the humorous speech and the chatting speech.

Here, the generation of the humorous speech may include selecting the core word from the user speech and performing pronunciation string conversion on the core word in units of pronunciation, extracting words similar to the core word pronunciation string based on a phonological dictionary or a phonological similarity table and calculating word similarity, arranging the words similar to the similar core word pronunciation string using the word similarity as a criterion and selecting an example sentence from among sentences including the words similar to the core word pronunciation string, and substituting the word similar to the core word pronunciation string in the example sentence with the core word and generating the humorous speech.

Here, the generation of the humorous speech may include extracting the abbreviated word included in the user speech, retrieving an original meaning of the abbreviated word using an abbreviated word dictionary or web information, selecting the original word corresponding to the abbreviated word, and restoring an original sentence, selecting another word identical to an initial sound of the original word and generating an initial sound character, and changing the original sentence using the initial sound character and generating the humorous speech.

Here, the generation of the initial sound character may include extracting a core portion from the original word through morphological analysis and syntactic analysis of the original word, and changing the original word excluding the core portion and using the other word identical to the initial sound of the original word.

According to still another aspect of the present invention for achieving the foregoing objects, a humorous speech generation apparatus receiving user speech and generating humorous speech includes: a first humor generation module that generates humorous speech by selecting a core word from the user speech, performing pronunciation string conversion on the core word in units of pronunciation, selecting an example sentence from among sentences including words similar to a core word pronunciation string, and substituting the word similar to the core word pronunciation string in the example sentence with the core word; and a second humor generation module that extracts an abbreviated word included in user speech, retrieves an original word having the original meaning of the abbreviated word, and generates the humorous speech using an initial sound character generated based on another word identical to the initial sound of the original word.

### Advantageous Effects

The voice dialog system and method using humorous speech according to an embodiment of the present invention described above provide a user with humorous speech so that the user does not feel bored and can have fun using a chatting dialog system.

Further, various types of humorous speech can be provided without providing only simple and repeated speech by selecting final speech from among the various types of humorous speech.

### DESCRIPTION OF DRAWINGS

FIG. 1 is a block diagram for describing an operation of a voice dialog system of the related art.

FIG. 2 is a block diagram for describing an operation of a voice dialog system using humorous speech according to an embodiment of the present invention.

FIG. 3 is a conceptual diagram for describing the configuration of a humorous speech generation unit according to the embodiment of the present invention.

FIG. 4 is a flowchart for describing a voice dialog method according to the embodiment of the present invention.

FIG. 5 is a flowchart for describing an operation of the humorous speech generation unit according to the embodiment of the present invention.

FIGS. 6A to 6C are an exemplary diagram illustrating a phonological dictionary and a phonological similarity table utilized according to the embodiment of the present invention.

FIGS. 7A and 7B are an exemplary diagram for describing a method of calculating word similarity according to the embodiment of the present invention.

FIG. 8 is an exemplary diagram for describing the selection of an example sentence according to the embodiment of the present invention.

FIG. 9 is a flowchart for describing an operation of a humorous speech generation unit according to another embodiment of the present invention.

FIG. 10 is a flowchart for describing an operation of a final speech selection unit according to the embodiment of the present invention.

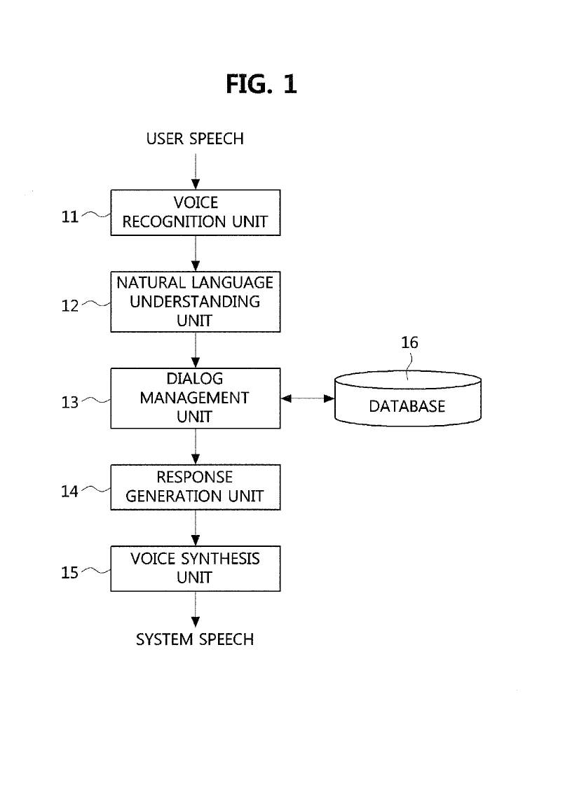

### MODES OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms “first,” “second,” “A,” “B,” etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Terms will be defined to clearly describe embodiments of the present invention.

Humor refers to a word or a behavior that causes others to laugh and may refer to elements that amusingly progress dialogs in a chatting dialog system. Humor may make audiences laugh abruptly through an unexpected word about a specific phenomenon or objects while conversations or situational descriptions known to the audiences logically progress so that anyone feels sympathy.

Humor may be classified into a set-up portion and a punch-line portion. The set-up portion is a precondition of the humor and refers to a description of preliminary knowledge for making people laugh by humor. That is, by logically describing corresponding situations to sympathetic audiences, the audiences may be caused to feel sympathy with the situations, and thus to expect what will occur in the future in dialog flows and appearances of dialogs. The punch-line portion is the most important portion of the humor and refers to a word which makes the audiences laugh. A word different or unanticipated from the expectation of the audience formed through the set-up portion makes the audiences laugh because of different expectations.

In the present specification, speech including humor may refer to humorous speech and a general response to a user's speech through a chatting dialog system may refer to chatting speech. Accordingly, speech may be classified into humorous speech and chatting speech depending on whether humor is included in the speech.

Further, a user's speech refers to speech input as a voice to a chatting dialog system and a system's speech refers to speech supplied as a response to the user's speech by a chatting dialog system.

Hereinafter, exemplary embodiments of the present invention will be described in detail with reference to the appended drawings.

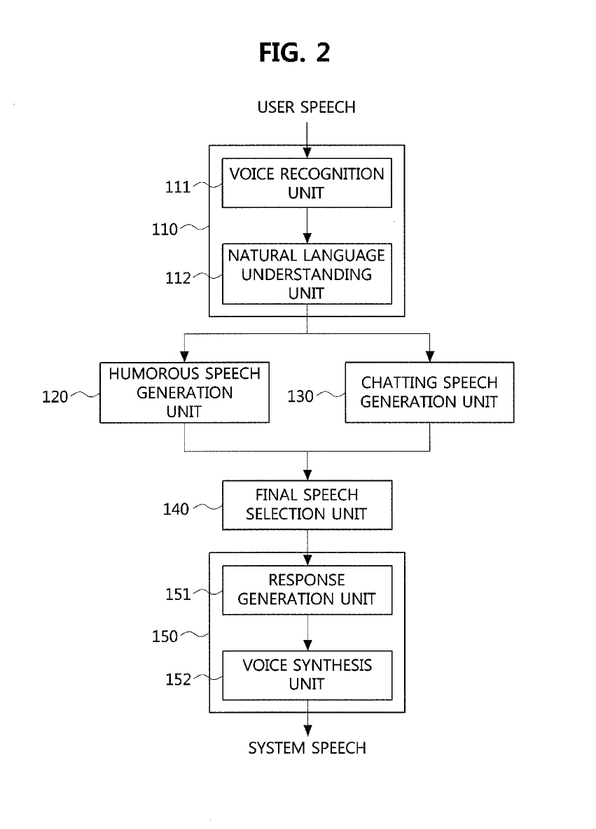

FIG. 2 is a block diagram illustrating an operation of a voice dialog system using humorous speech according to an embodiment of the present invention.

Referring to FIG. 2, the voice dialog system according to the embodiment of the present invention includes a speech analysis unit 110, a humorous speech generation unit 120, a chatting speech generation unit 130, a final speech selection unit 140, and a system speech supply unit 150.

The speech analysis unit 110 may analyze a user's intention by receiving user speech and converting the user speech into text.

Specifically, the speech analysis unit 110 includes a voice recognition unit 111 and a natural language understanding unit 112. The voice recognition unit 111 may convert the user speech input as a voice into text and the natural language understanding unit 112 may analyze the user's intention using the user speech converted into the text.

The humorous speech generation unit 120 and the chatting speech generation unit 130 may generate humorous speech and chatting speech, respectively, based on the analyzed user's intention.

The humorous speech generation unit 120 may generate the humorous speech using a core word or an abbreviated word included in the user speech based on the user's intention.

The humorous speech generation unit 120 may generate the humorous speech according to various methods.

First, the humorous speech generation unit 120 may generate humorous speech by searching for a word with similar pronunciation based on pronunciation similarity of the core word included in the user speech and substituting the word with the core word. For example, a humorous speech generation method of such a scheme is referred to as a “wordplay sentence generation method.

The generation of the humorous speech according to the “wordplay sentence generation method” will be described.

The humorous speech generation unit 120 may generate humorous speech by selecting a core word from the user speech, performing pronunciation string conversion on the core word in units of pronunciation, selecting an example sentence from among sentences including a word similar to the core word pronunciation string, and substituting the word similar to the core word pronunciation string in the example sentence with the core word.

That is, the humorous speech generation unit 120 may extract words similar to the core word pronunciation string based on a phonological dictionary or a phonological similarity table, calculate word similarity, arrange the words similar to the core word pronunciation string using the word similarity as a criterion, and select the example sentence from among sentences including the words similar to the core word pronunciation string. Here, the phonological dictionary means a uni-gram phonological dictionary or a bi-gram phonological dictionary.

Next, the humorous speech generation unit 120 may restore an abbreviated word included in the user speech to an original word having the original meaning and generate humorous speech using an initial sound character generated based on different words identical to the initial sound of the original word. For example, a humorous speech generation method of such a scheme is referred to as an “abbreviated word-based initial sound character generation method.”

The generation of humorous speech according to the “abbreviated word-based initial sound character generation method” will be described.

The humorous speech generation unit 120 may extract an abbreviated word included in the user speech, retrieve an original word having the original meaning of the abbreviated word, and generate the humorous speech using an initial sound character generated based on different words identical to the initial sound of the original word.

On the other hand, the humorous speech generation unit 120 may restore an original sentence by retrieving the original meaning of the abbreviated word using an abbreviated word dictionary or web information and selecting the original word corresponding to the abbreviated word and may generate the humorous speech by changing the original sentence using the initial sound character.

The final speech selection unit 140 may select final speech from among humorous speech and chatting speech. The final speech selection unit 140 may select the final speech from among the humorous speech and the chatting speech based on a similarity score of the humorous speech or a probability value indicating sentence naturalness in accordance with the humorous speech.

The system speech supply unit 150 may generate system speech which is a response to the user speech using the final speech and convert the system speech into a voice to provide the voice. The system speech supply unit 150 includes a response generation unit 151 and a voice synthesis unit 152. The response generation unit 151 may generate system speech which is a response to the user speech using the selected final speech. The voice synthesis unit 152 may convert the system speech into an actual voice to express the actual voice.

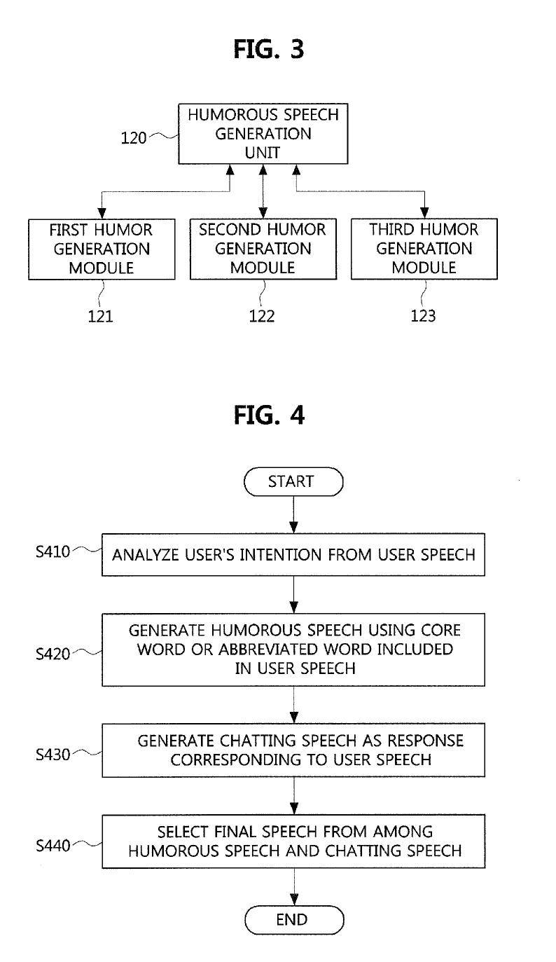

FIG. 3 is a conceptual diagram for describing the configuration of the humorous speech generation unit 120 according to the embodiment of the present invention.

Referring to FIG. 3, the humorous speech generation unit 120 may utilize at least one humor generation module. That is, the humorous speech generation unit 120 may utilize a first humor generation module 121, a second humor generation module 122, and a third humor generation module 123. The humor generation modules may generate humor speech according to different techniques.

The humorous speech generation unit 120 may add or delete a method of generating humorous speech by adding or deleting a new humor generation module. That is, the addition or deletion of each humor generation module has no influence on another humor generation module. Thus, the humorous speech generation unit 120 may have expansibility in generation of humorous speech.

Accordingly, the humorous speech generation unit 120 may be constructed by a distribution structure of respective humor generation modules.

For example, the first humor generation module 121 may generate humorous speech according to the “wordplay sentence generation method” and the second humor generation module 122 may generate humorous speech according to the “abbreviated word-based initial sound character generation method.”

Thus, according to the embodiment of the present invention, a humorous speech generation apparatus receiving user speech and generating humorous speech may include the first humor generation module 121 that generates humorous speech by selecting a core word from the user speech, performing pronunciation string conversion on the core word in units of pronunciation, selecting an example sentence from among sentences including words similar to a core word pronunciation string, and substituting the word similar to the core word pronunciation string in the example sentence with the core word.

The humorous speech generation apparatus may include the second humor generation module 122 that extracts an abbreviated word included in user speech, retrieves an original word having the original meaning of the abbreviated word, and generates the humorous speech using an initial sound character generated based on another word identical to the initial sound of the original word.

The respective constituent elements of the voice dialog system or the humorous speech apparatus according to the embodiment of the present invention have been listed and described as respective constituent elements to facilitate the description. At least two of the constituent elements may be combined to one constituent element or one constituent element may be divided into a plurality of constituent elements to carry out the function. Embodiments in which the constituent elements are integrated or divided are included within the technical scope of the present invention without departing from the gist of the present invention.

An operation of the voice dialog system or the humor generation apparatus according to the embodiment of the present invention may be realized as computer-readable programs or codes in computer-readable recording media. The computer-readable recording media include all types of recording devices in which data readable by computer systems are stored. The computer-readable recording media may be distributed to computer systems connected via networks and the computer-readable programs or codes may be stored and executed in a distribution manner.

FIG. 4 is a flowchart for describing a voice dialog method according to the embodiment of the present invention.

A voice dialog method illustrated in FIG. 4 includes a step S410 of analyzing a user's intention, a step S420 of generating humorous speech, a step S430 of generating chatting speech, and a step S440 of selecting final speech.

The user speech may be received and converted into text to analyze a user's intention (S410).

The humorous speech may be generated using the core word or the abbreviated word included in the user speech based on the user's intention (S420).

For example, the humorous speech may be generated according to the above-described “wordplay sentence generation method” or the “abbreviated word-based initial sound character generation method.”

The chatting speech may be generated as the response corresponding to the user speech (S430). The chatting speech may be generated as the response to the user speech through analysis of the user's intention using the user speech. For example, the chatting speech may be generated according to a scheme used in a conventional dialog system and the method of generating the chatting speech is not particularly limited.

The final speech may be selected from among the humorous speech and the chatting speech (S440). That is, one of the humorous speech and the chatting speech may be selected as the final speech. A criterion for selecting the final speech may be set variously. In particular, the final speech may be selected using humorous speech similarity or sentence naturalness as the criterion.

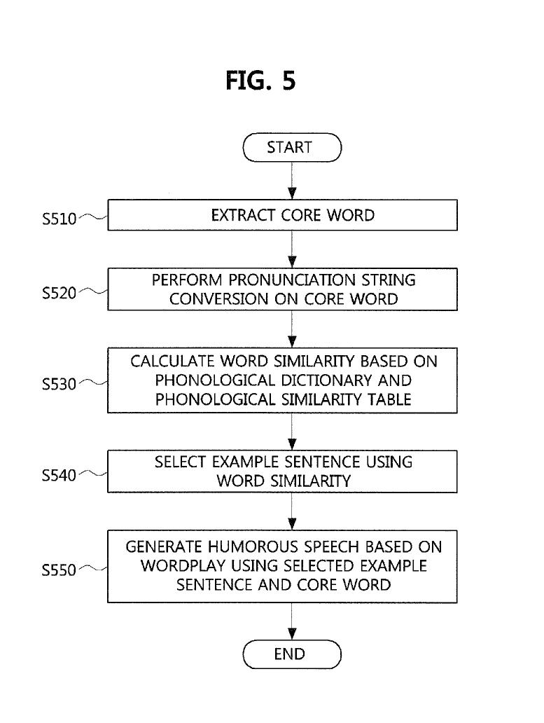

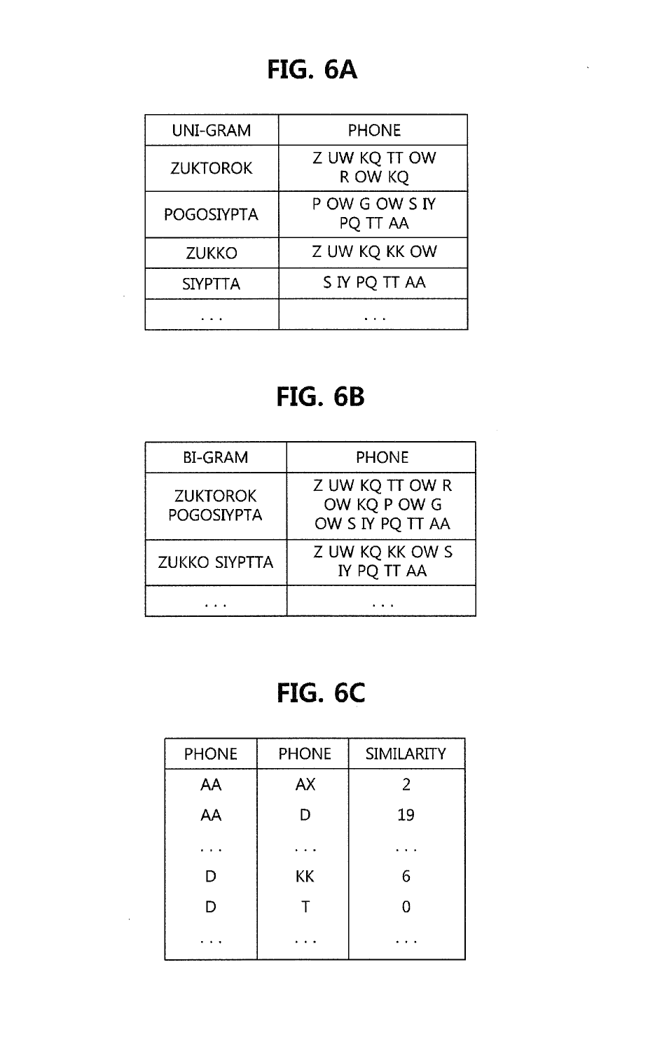

FIG. 5 is a flowchart for describing an operation of the humorous speech generation unit 120 according to the embodiment of the present invention. FIG. 6 is an exemplary diagram illustrating a phonological dictionary and a phonological similarity table according to the embodiment of the present invention.

Referring to FIG. 5, the “wordplay sentence generation method” performed by the humorous speech generation unit 120 will be described.

A core word is selected from the user speech based on the user's intention (S510). The pronunciation string conversion may be performed using the core word selected from the user speech as units of phones (S520). For example, when a word “CHUKKU” is selected as the core word, the core word may be converted into a pronunciation string “CH UW KQ KK UW.”

A word similarity may be calculated by extracting a word similar to the pronunciation string of the core word based on a phonological dictionary or a phonological similarity table (S530). That is, the word similar to the pronunciation string of the core word may be searched for.

A uni-gram or a bi-gram phonological dictionary may be constructed based on a dialog training document collected to search for a similar word and the word similarity between the core word and a word in a dictionary may be measured.

FIG. 6A is an exemplary diagram illustrating a uni-gram phonological dictionary. FIG. 6B illustrates a phonological dictionary for the bi-gram phonological dictionary.

That is, the uni-gram phonological dictionary depends on only a probability value at which a current word appears, irrespective of previously shown words and the bi-gram phonological dictionary may be expressed in a form that depends on an immediate past.

A Levenshtein distance method and a Korean phonological similarity table may be used to measure word similarity. In the Korean phonological similarity table, pronunciations of Koreans are classified into 50 types and similarity between pronunciations is recorded.

FIG. 6C is an exemplary diagram illustrating a phonological similarity table. For example, the phonological similarity may indicate a more similar pronunciation as a value of the phonological similarity is lower.

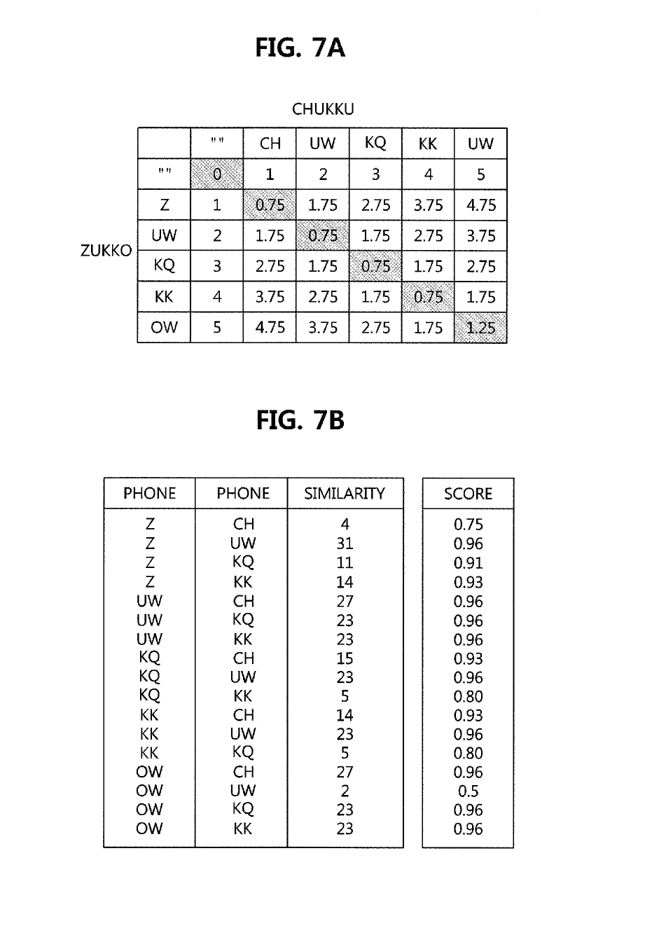

FIG. 7 is an exemplary diagram for describing a method of calculating word similarity according to the embodiment of the present invention.

Referring to FIG. 7, the calculation of word similarity in which “CHUKKU” is a core word will be described. FIG. 7A illustrates the similarity between pronunciation strings of “ZUKKO” and “CHUKKU” and FIG. 7B illustrates the similarity scores of the similarity of pronunciation strings.

According to the embodiment of the present invention, similarity between pronunciation strings may be measured using the Levenshtein distance method and the Korean phonological similarity table.

For example, when a new word is inserted, when a word is deleted, or when a word is substituted, the degree of change between words may be calculated to 1 and an inter-word distance may be calculated. Then, as the value of the distance is lower, words may be determined to be more similar.

As another method, when a word is substituted and a distance is calculated using a numerical value expressed with (1−1/similarity), a lower substitution numerical value may be shown as similarity is higher (pronunciation is more similar).

Words similar to the core word pronunciation string may be arranged using the word similarity as the criterion and an example sentence may be selected from among sentences including a word similar to the core word pronunciation string (S540).

For example, the sentences including a word similar to the core word pronunciation string may be arranged in an ascending order based on the similarity scores. That is, a word ranked higher may be the most similar to the given core word in terms of pronunciation.

An example sentence including a word for which word similarity calculated between the core word and a pronunciation string in the uni-gram or bi-gram phonological dictionary is equal to or less than a present threshold may be selected.

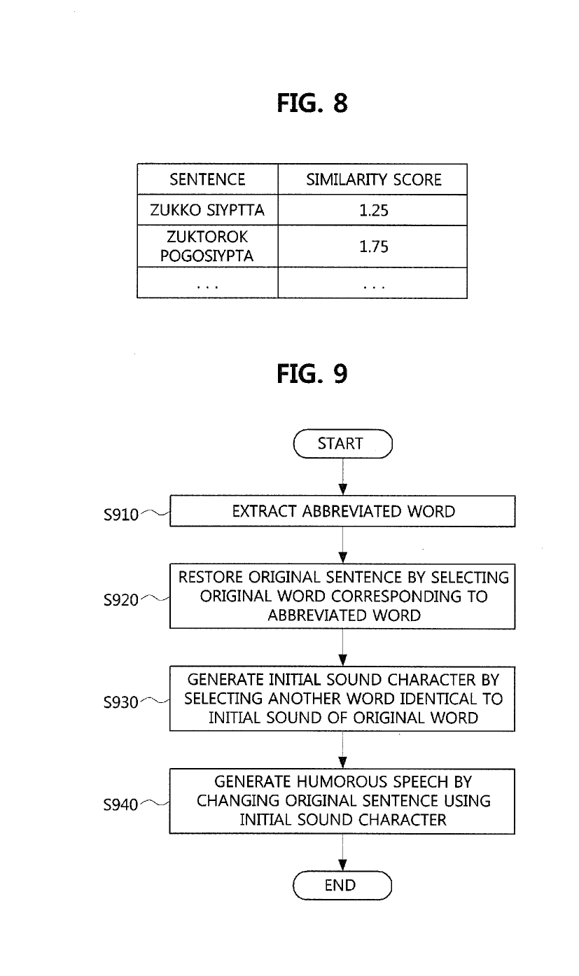

FIG. 8 is an exemplary diagram for describing the selection of an example sentence according to the embodiment of the present invention.

When the most similar word to “CH UW KQ KK UW” which is the pronunciation string of the core word “CHUKKU” is assumed to be “ZUKKO,” “ZUKKO SIYPTTA” which is an example originally including the word “ZUKKO” may be selected as an example sentence.

Humorous speech may be generated by substituting the word similar to the core word pronunciation word in the example sentence with the core word.

For example, when an example sentence “ZUKKO SIYPTTA” is selected, humorous speech “CHUKKU SIYPTTA” may be generated by substituting a comparison target word “ZUKKO” with the core word “CHUKKU.”

FIG. 9 is a flowchart for describing an operation of the humorous speech generation unit 120 according to another embodiment of the present invention.

Referring to FIG. 9, the “abbreviated word-based initial sound character generation method” performed by the humorous speech generation unit 120 will be described.

First, an abbreviated word included in the user speech may be extracted (S910). Here, the abbreviated word refers to a language used by compressing a word to be shorter when the generally used word is too long. For example, a word “Mudo” abbreviated from “Muhandogeon” or a word “Binaeng” abbreviated from “Bibim-Naengmyeon” corresponds to an abbreviated word.

On the other hand, the original sentence may be restored by retrieving the original meaning of the abbreviated word using an abbreviated word dictionary or web information and selecting the original word corresponding to the abbreviated word (S920).

A word having the original meaning of the abbreviated word may be searched for. That is, the word having the original meaning of the abbreviated word may be retrieved using an abbreviated word dictionary and web information. For example, when characters “Binaeng” is entered, the abbreviated word may be restored to the original meaning “Bibim-Naengmyeon.”

The initial sound character may be generated by selecting another word identical to the initial sound of the original word (S930). The initial sound character may be generated according to a “random generation” or “dictionary-based generation” method.

In the “random generation method,” the initial sound character may be generated by retrieving other words identical to the initial sound among from words forming the original sentence of the abbreviated word and selecting a word to be substituted at random.

In the “dictionary-based generation” method, a portion to be changed and a portion not to be changed may be determined among the words forming the original sentence through morphological analysis and parsing and a word may be converted using dictionary information or Wordnet information.

That is, the original word may be changed by extracting a core portion in the original word through the morphological analysis and syntactic analysis of the original word, excluding the core portion and using another word identical to the initial sound of the original word.

For example, when the word “Bibim-Naengmyeon” is entered, information “Bibim/NN and Naengmyeon/NN” may be obtained through morphological analysis and “Naengmyeon” may be comprehended to be the core portion through syntactic analysis.

In the “dictionary-based generation” method, a word changed based on a dictionary and Wordnet may be generated. The portion not to be changed and the portion to be changed may be determined based on the results of the morphological analysis and the syntactic analysis.

When the word “Bibim-Naengmyeon” is given, “Naengmyeon” may be determined as the word not to be changed and “Bibim” may be determined as the word to be changed, and a word “Birin” which is identical to the initial sound of “Bibim” and has another meaning may be searched for. That is, a word “Birin-Naengmyeon” including “Birin” and “Naengmyeon” which is a core portion may be generated as initial sound characters.

Then, the humorous speech may be generated by changing the original sentence using the initial sound characters (S940).

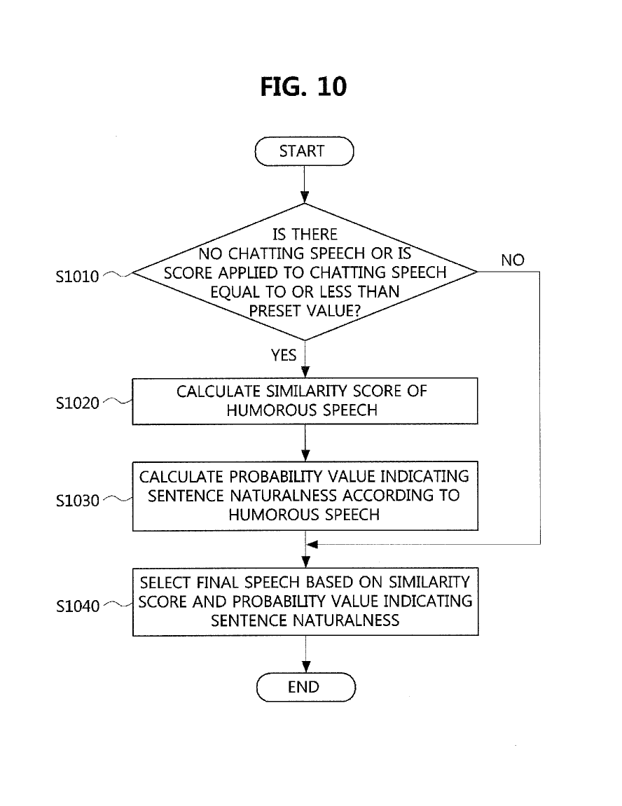

FIG. 10 is a flowchart for describing an operation of the final speech selection unit 140 according to the embodiment of the present invention.

Referring to FIG. 10, the final speech may be selected from the humorous speech and the chatting speech.

The final speech may be selected according to a strategy for generating humor in the dialog system. The final speech may be selected according to a random selection method and a score-based selection method.

In the random selection method, system speech may be selected by selecting one speech among from M types of humorous speech and N types of chatting speeches at random.

In the score-based selection method, a score of the final speech may be calculated using a similarity core and a humor speech language model score calculated at the time of generation of humor speech, and the final speech may be selected based on a final score.

That is, the final speech may be selected from among the humorous speech and the chatting speech based on the similarity score of the humorous speech and a probability value indicating sentence naturalness according to the humorous speech.

In the score-based selection method, when there is no chatting speech or a score applied to the chatting speech is equal to or less than a preset threshold, one type of the humorous speech may be selected as the final speech (S1010).

The final speech may be selected based on a similarity score calculated according to each humorous speech generation method and a humor language model score (humor LM score) indicating how natural a generated sentence is. A score for selecting the final speech is calculated using the following Equation 1.

Total Score=α*(similarity score)+β*(Humor LM score) [Equation 1]

In the generation of the humorous speech, the humorous speech may be generated based on the given sentence or the core word. Here, a score measurement method for the similarity score may be different according to a humor generation method. Therefore, the similarity score may be set to a value between 0 and 1.

The probability value may be obtained through a humor language model of the generated humor speech. The humor language model score is a barometer that indicates how natural the generated humor actually is and may be expressed as a probability value between 0 and 1. Here, α and μ mean coefficients for normalization.

In order to train the humor language model, a language model may be trained using various types of humor-related data. Humorous speech, collected humorous speech, a slang word dictionary, and the like generated during the training may be used as the humor-related data.

Finally, the system speech which is a response to the user speech may be generated using the final speech, the system speech may be converted into a voice, and the voice may be supplied to a user.

As described above, the voice dialog system and method using the humorous speech according to the embodiment of the present invention provide a user with humorous speech so that the user does not feel bored and can have fun using a chatting dialog system.

The structure performing management by adding or deleting the humorous speech generation method in a scalability manner is provided.

By selecting the final speech among from various types of humorous speech and supplying the final speech, the various types of humorous speech can be supplied rather than supplying only simple and repeated speech.

While the invention has been shown and described with reference to certain exemplary embodiments thereof, it will be understood by those skilled in the art that various changes in form and details may be made therein without departing from the spirit and scope of the invention as defined by the appended claims.

1. A voice dialog system comprising:
a speech analysis unit that analyzes a user's intention by receiving user speech and converting the user speech into text;
a humorous speech generation unit that generates humorous speech using a core word or an abbreviated word included in the user speech based on the user's intention;
a chatting speech generation unit that generates chatting speech as a response corresponding to the user's intention; and
a final speech selection unit that selects final speech from among the humorous speech and the chatting speech.

2. The voice dialog system of claim 1, wherein the humorous speech generation unit generates the humorous speech by being configured to select the core word from the user speech, perform pronunciation string conversion on the core word in units of pronunciation, select an example sentence from among sentences including a word similar to the core word pronunciation string, and substitute the word similar to the core word pronunciation string in the example sentence with the core word.

3. The voice dialog system of claim 2, wherein the humorous speech generation unit extracts words similar to the core word pronunciation string based on a phonological dictionary or a phonological similarity table, calculates word similarity, arranges the words similar to the core word pronunciation string using the word similarity as a criterion, and selects the example sentence from among sentences including the words similar to the core word pronunciation string.

4. The voice dialog system of claim 3, wherein the phonological dictionary is a uni-gram phonological dictionary or a bi-gram phonological dictionary.

5. The voice dialog system of claim 1, wherein the humorous speech generation unit extracts the abbreviated word included in the user speech, retrieves an original word having an original meaning of the abbreviated word, and generates the humorous speech using an initial sound character generated based on different words identical to an initial sound of the original word.

6. The voice dialog system of claim 5, wherein the humorous speech generation unit restores an original sentence by being configured to retrieve the original meaning of the abbreviated word using an abbreviated word dictionary or web information and select the original word corresponding to the abbreviated word, and generates the humorous speech by changing the original sentence using the initial sound character.

7. The voice dialog system of claim 1, wherein the humor speech generation unit includes at least one humor generation module generating the humor speech in accordance with a different scheme.

8. The voice dialog system of claim 1, wherein the final speech selection unit selects the final speech from among the humorous speech and the chatting speech based on a similarity score of the humorous speech or a probability value indicating sentence naturalness in accordance with the humorous speech.

9. The voice dialog system of claim 1, further comprising:
a system speech supply unit that generates system speech which is a response to the user speech using the final speech and converts the system speech into a voice to provide the voice.

10. A voice dialog method processed in a voice dialog system, comprising:
analyzing a user's intention by receiving user speech and converting the user speech into text;
generating humorous speech using a core word or an abbreviated word included in the user speech based on the user's intention;
generating chatting speech as a response corresponding to the user's intention; and
selecting final speech from among the humorous speech and the chatting speech.

11. The voice dialog method of claim 10, wherein the generating of the humorous speech includes
selecting the core word from the user speech and performing pronunciation string conversion on the core word in units of pronunciation,
extracting words similar to the core word pronunciation string based on a phonological dictionary or a phonological similarity table and calculating word similarity,
arranging the words similar to the similar core word pronunciation string using the word similarity as a criterion and selecting an example sentence from among sentences including the words similar to the core word pronunciation string, and
substituting the word similar to the core word pronunciation string in the example sentence with the core word and generating the humorous speech.

12. The voice dialog method of claim 10, wherein the phonological dictionary is a uni-gram phonological dictionary or a bi-gram phonological dictionary.

13. The voice dialog method of claim 10, wherein the generating of the humorous speech includes
extracting the abbreviated word included in the user speech,
retrieving an original meaning of the abbreviated word using an abbreviated word dictionary or web information, selecting the original word corresponding to the abbreviated word, and restoring an original sentence,
selecting another word identical to an initial sound of the original word and generating an initial sound character, and
changing the original sentence using the initial sound character and generating the humorous speech.

14. The voice dialog method of claim 13, wherein the generating of the initial sound character includes
extracting a core portion from the original word through morphological analysis and syntactic analysis of the original word, and
changing the original word excluding the core portion and using the other word identical to the initial sound of the original word.

15. The voice dialog method of claim 10, wherein the selecting of the final speech includes selecting the final speech from among the humorous speech and the chatting speech based on a similarity score of the humorous speech or a probability value indicating sentence naturalness in accordance with the humorous speech.

16. The voice dialog method of claim 10, further comprising:
generating system speech which is a response to the user speech using the final speech and converting the system speech into a voice to provide the voice.

17. A humorous speech generation apparatus receiving user speech and generating humorous speech, comprising:
a first humor generation module that generates humorous speech by being configured to select a core word from the user speech, perform pronunciation string conversion on the core word in units of pronunciation, select an example sentence from among sentences including words similar to a core word pronunciation string, and substitute the word similar to the core word pronunciation string in the example sentence with the core word; and
a second humor generation module that extracts an abbreviated word included in user speech, retrieves an original word having the original meaning of the abbreviated word, and generates the humorous speech using an initial sound character generated based on another word identical to the initial sound of the original word.

18. The humorous speech generation apparatus of claim 17, wherein the first humor generation module extracts the words similar to the core word pronunciation string based on a phonological dictionary or a phonological similarity table, calculates word similarity, arranges the words similar to the similar core word pronunciation string using the word similarity as a criterion, and selects the example sentence from among sentences including the words similar to the core word pronunciation string.

19. The humorous speech generation apparatus of claim 17, wherein the second humor generation module restores an original sentence by being configured to retrieve the original meaning of the abbreviated word using an abbreviated word dictionary or web information and select the original word corresponding to the abbreviated word, and generates the humorous speech by changing the original sentence using the initial sound character.
